(19) United States
(12) Patent Application Publication
(10) Pub. No.: US 2026/0003602 A1
(43) Pub. Date: Jan. 1, 2026

(54) APPLICATION CREATION

(71) Applicant: Beijing Zitiao Network Technology Co., Ltd., Beijing (CN)

(72) Inventor: Xuneng HUANG, Beijing (CN)

(21) Appl. No.: 18/986,044

(22) Filed: Dec. 18, 2024

(30) Foreign Application Priority Data
Jun. 30, 2024 (CN) 202410870547.0

(51) Int. Cl. G06F 8/65; G06F 9/445

(52) U.S. Cl. CPC G06F 8/65; G06F 9/44526

(57) ABSTRACT

The embodiments of the disclosure relate to a method, apparatus, device and storage medium for application creation. The method proposed herein includes: providing, in an application editing interface, a first configuration control associated with a target processing component; setting the target processing component to an asynchronous operating mode via the first configuration control; and creating a target application including the target processing component, the target application being configured to, during an operation of the target processing component based on a trigger by a first message and in response to receiving a second message, process the second message without waiting for completion of the operation of the target processing component.

### CROSS-REFERENCE

The present application claims priority to Chinese Patent Application No. 202410870547.0, filed on Jun. 30, 2024, and entitled “APPLICATION CREATION METHOD, APPARATUS, DEVICE AND STORAGE MEDIUM”, the entirety of which is incorporated herein by reference.

### FIELD

Example embodiments of the present disclosure generally relate to the field of computers, and more particularly, to application creation.

### BACKGROUND

With the development of computer technologies, people can create and release various types of applications on different platforms. For example, with the development of machine learning techniques, one can quickly create an application by configuring parameters of the application, such as a model used by the application, available plug-ins, and so on.

### SUMMARY

In a first aspect of the present disclosure, a method for application creation is provided. The method includes: providing, in the application editing interface, a first configuration control associated with a target processing component; setting the target processing component to an asynchronous operating mode via the first configuration control; and creating a target application including the target processing component, the target application being configured to, during an operation of the target processing component based on a trigger by a first message and in response to receiving a second message, process the second message without waiting for completion of the operation of the target processing component.

In a second aspect of the present disclosure, a method for processing a request is provided. The method includes: triggering a target processing component of a target application to operate based on a first message received by the target application, the target processing component being configured to operate in an asynchronous operating mode; receiving a second message via the target application before completion of execution of the target processing component; and providing a first response content for the second message independently of an operation state of the target processing component.

In a third aspect of the present disclosure, an apparatus for application creation is provided. The apparatus includes: a providing module configured to provide, in the application editing interface, a first configuration control associated with a target processing component; a setting module configured to set the target processing component to an asynchronous operating mode via the first configuration control; and a creating module configured to create a target application including the target processing component, the target application being configured to, during an operation of the target processing component based on a trigger by a first message and in response to receiving a second message, process the second message without waiting for completion of the operation of the target processing component.

In a fourth aspect of the present disclosure, an apparatus for processing a request is provided. The apparatus includes: an executing module configured to trigger a target processing component of a target application to operate based on a first message received by the target application, the target processing component being configured to operate in an asynchronous operating mode; a receiving module configured to receive a second message via the target application before completion of execution of the target processing component; and an outputting module configured to provide a first response content for the second message independently of an operation state of the target processing component.

In a fifth aspect of the present disclosure, an electronic device is provided. The device includes at least one processing unit; and at least one memory, the at least one memory being coupled to the at least one processing unit and storing instructions for execution by the at least one processing unit. The instructions, when executed by the at least one processing unit, cause the electronic device to perform operations that implement the method of the first aspect or the second aspect.

In a sixth aspect of the present disclosure, a computer readable storage medium is provided. The computer readable storage medium stores a computer program thereon, and the computer program is executable by a processor to perform operations that implement the method of the first aspect or the second aspect.

It would be appreciated that what is described in this Summary section is not intended to limit critical features or essential features of embodiments of the present disclosure, nor is it intended to limit the scope of the present disclosure. Other features of the present disclosure will become readily appreciated from the following description.

### BRIEF DESCRIPTION OF THE DRAWINGS

The above and other features, advantages, and aspects of various embodiments of the present disclosure will become more apparent with reference to the following detailed description taken in conjunction with the accompanying drawings. In the drawings, the same or similar reference numerals denote the same or similar elements, wherein:

FIG. 1 illustrates a schematic diagram of an example environment.

FIG. 2A illustrates a flowchart of an example process for application creation.

FIG. 2B illustrates a flowchart of an example process for processing a request.

FIG. 3A illustrates an example editing interface.

FIG. 3B illustrates an example debug interface.

FIG. 3C illustrates an example running interface.

FIG. 4A illustrates a schematic structural block diagram of an example apparatus for application creation.

FIG. 4B illustrates a schematic structural block diagram of an example apparatus for application creation.

FIG. 5 illustrates a block diagram of an example electronic device in which various embodiments of the present disclosure may be implemented.

### DETAILED DESCRIPTION

The embodiments of the present disclosure will be described in more detail below with reference to the accompanying drawings. Although certain embodiments of the present disclosure are shown in the accompanying drawings, it should be understood that the present disclosure may be implemented in various forms and should not be construed as limited to the embodiments set forth herein, but rather, these embodiments are provided for a thorough and complete understanding of the present disclosure. It should be understood that the drawings and embodiments of the present disclosure are only for illustrative purposes and are not intended to limit the scope of the present disclosure.

It should be noted that the headings of any section/subsection provided herein are not limiting. Various embodiments are described throughout herein, and any type of embodiment can be included under any section/subsection. Furthermore, embodiments described in any section/subsection may be combined in any manner with any other embodiments described in the same section/subsection and/or different sections/subsections.

In the description of the embodiments of the present disclosure, the term “including” and the like should be understood as open-ended including, that is, “including but not limited to”. The term “based on” should be read as “based at least in part on.” The term “one embodiment” or “the embodiment” should be read as “at least one embodiment”. The term “some embodiments” should be understood as “at least some embodiments”. Other explicit and implicit definitions may also be included below. The terms “first”, “second”, etc. may refer to different or identical objects. Other explicit and implicit definitions may also be included below.

The embodiments of the present disclosure may relate to user data, acquisition and/or use of data, and the like. These aspects shall comply with the requirements of corresponding laws, regulations and relevant provisions. In the embodiments of the present disclosure, the collection, acquisition, processing, manufacturing, forwarding, use of all data and the like are carried out with the user's knowledge and consent. Accordingly, in the implementation of the embodiments of the present disclosure, users should be informed of the type, the scope of use, the use scenario, etc., of the involved data or information in an appropriate manner and provide authorization in accordance with relevant laws and regulations. The specific ways of being informed and providing authorization may vary according to actual circumstances and application scenarios, and the scope of this disclosure is not limited in this regard.

In the solutions and embodiments in this disclosure, if personal information processing is involved, it will be carried out based on legitimate grounds (such as obtaining consent from the data subject, or as required to fulfill a contract”, etc.) and will be processed only within the specified or agreed scope. If users decline the processing of personal information beyond what is essential for basic functionalities, their utilization of these basic features remains uninterrupted.

Conventionally, applications such as bots typically need to wait for a processing component to complete a certain request so as to process a subsequent request. However, some processing components may take a long time to complete processing, which greatly affects the efficiency of request processing.

The embodiments of the present disclosure propose a solution for application creation. According to the solution, a first configuration control associated with a target processing component may be provided in an application editing interface. Further, the target processing component may be set to an asynchronous operating mode via the first configuration control. Accordingly, a target application including a target processing component may be created. The created target application may be configured to, during an operation of the target processing component based on a trigger by a first message and in response to receiving a second message, process the second message without waiting for completion of the operation of the target processing component.

In this way, the embodiments of the present disclosure can support configuring a particular processing component in an application to operate asynchronously, thereby improving the execution efficiency of the application.

Various example implementations of the solution are described in further detail below with reference to the accompanying drawings.

### Example Environment

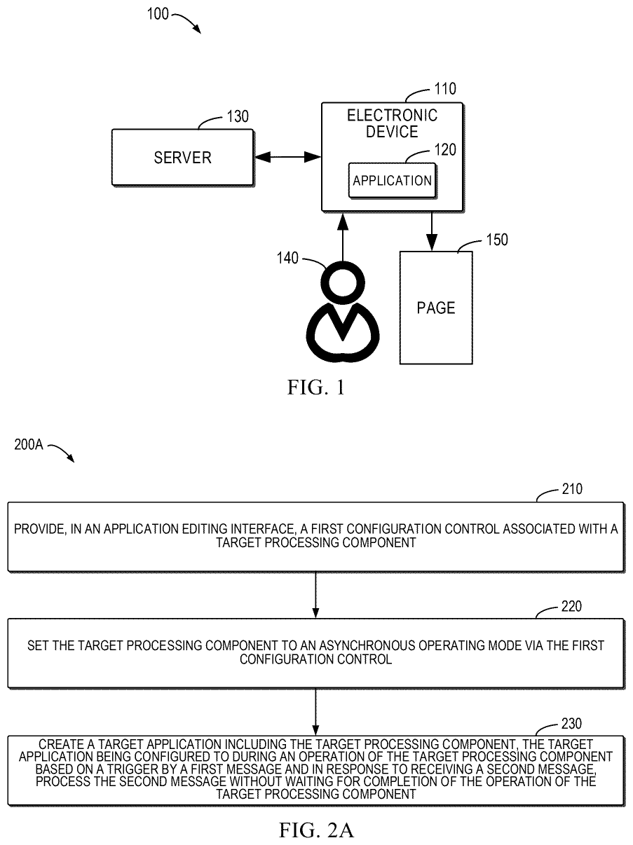

FIG. 1 shows a schematic diagram of an example environment 100 in which embodiments of the present disclosure can be implemented. As shown in FIG. 1, the example environment 100 may include an electronic device 110.

In this example environment 100, the electronic device 110 may run an application 120 that supports interface interaction. The application 120 may be any suitable type of application for interface interaction, examples of which may include, but are not limited to, development applications or other suitable applications that support workflow creation. A user 140 may interact with the application 120 via the electronic device 110 and/or its attached device.

In the environment 100 of FIG. 1, if the application 120 is active, the electronic device 110 may present, via the application 120, a page 150 for supporting workflow creation.

In some embodiments, the electronic device 110 communicates with a server 130 to enable provisioning of services to the application 120. The electronic device 110 may be any suitable type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 can also support any type of interface for a user (such as a “wearable” circuit, etc.).

The server 130 may be a standalone physical server, a server cluster composed of multiple physical servers, or a distributed system, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like. The server 130 may provide background services for the application 120 that support virtual scenes in the electronic device 110.

A communication connection may be established between the server 130 and the electronic device 110. The communication connection may be established in a wired manner or a wireless manner. The communication connection may include, but is not limited to, a Bluetooth connection, a mobile network connection, a Universal Serial Bus (USB) connection, a Wireless Fidelity (WiFi) connection, and the like, and the embodiments of the present disclosure are not limited in this aspect. In the embodiments of the present disclosure, the server 130 and the electronic device 110 may implement signaling interaction through a communication connection between the server 130 and the electronic device 110.

It would be appreciated that the structures and functions of the various elements in the environment 100 are described for exemplary purposes only and do not imply any limitation to the scope of the present disclosure.

Some example embodiments of the present disclosure will be described below with continued reference to the accompanying drawings.

### Example Processes

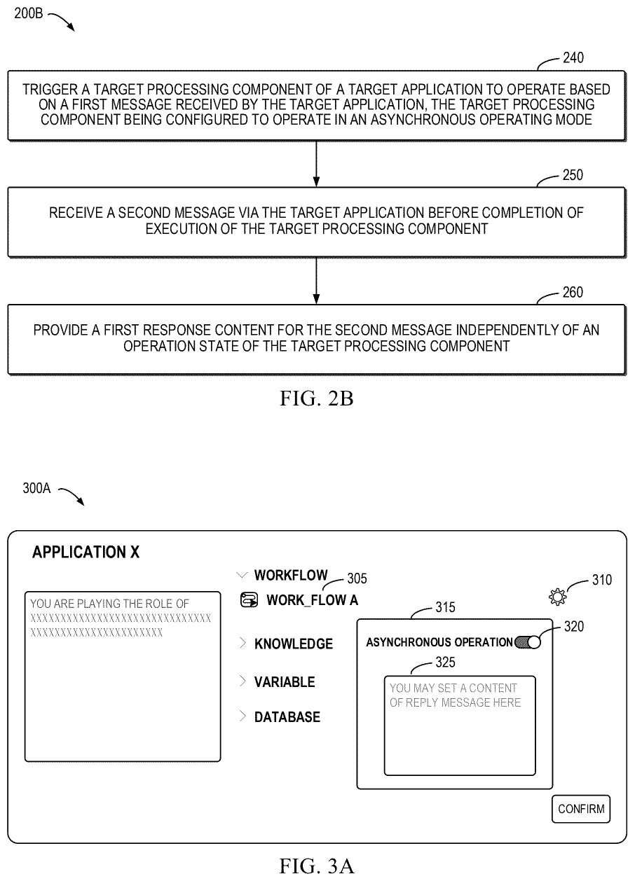

FIG. 2A illustrates a flowchart of a process 200A for application creation according to some embodiments of the present disclosure. In the context of the present disclosure, the “application creation” may be implemented in a variety of forms, for example, a new application (e.g., a bot) may be created using the example process 200A, and an existing application may also be opened and edited using an editing interface as described below. The process 200A may be implemented at the electronic device 110. The process 200A is described below with reference to FIG. 1.

As shown in FIG. 2A, at block 210, the electronic device 110 provides, in an application-editing interface, a first configuration control associated with a target processing component.

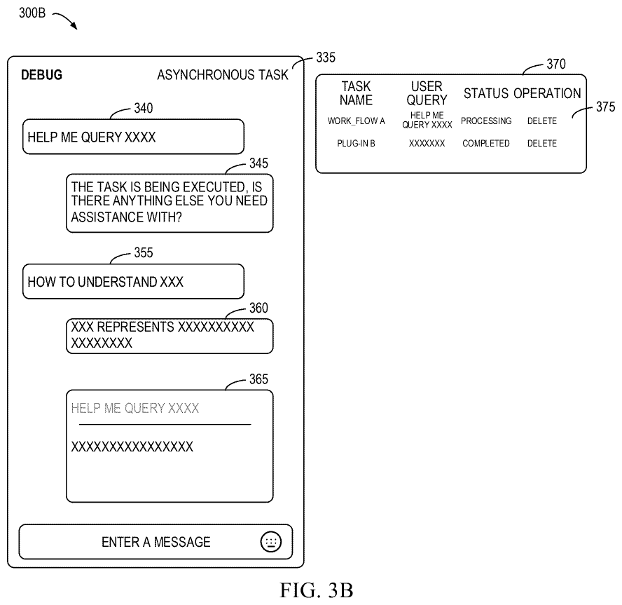

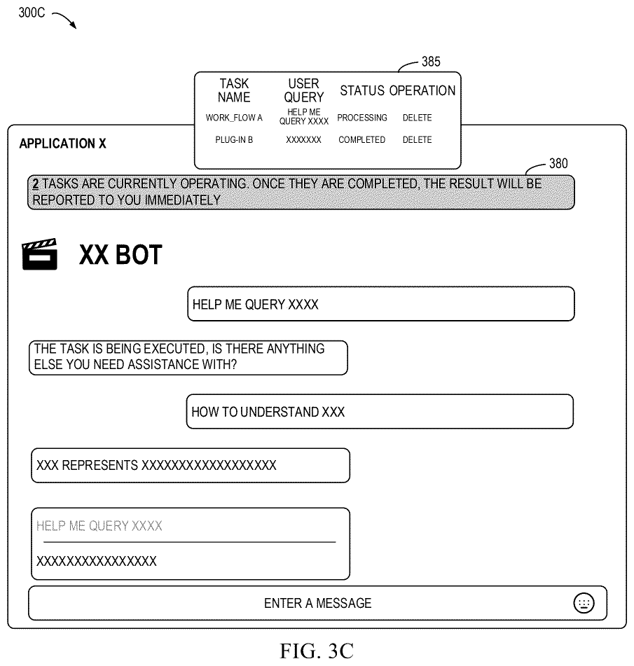

FIG. 3A illustrates an example application editing interface 300A according to some embodiments of the disclosure. As illustrated in FIG. 3A, the interface 300A can be used, for example, to edit “Application X” to create a new application or to edit an existing application. Such applications may include, for example, bots, agents, and the like.

As shown in FIG. 3A, the electronic device 110 may manage one or more processing components in the interface 300A added by the application. Such processing components may include, for example, but not limited to, a workflow component, image flow component, plug-in component, trigger component, etc. During execution of the application, the application may invoke such processing components to trigger execution of a corresponding processing task.

An example process for configuring a processing component will be described below with the workflow as an example of a processing component. As shown in FIG. 3A, the electronic device 110 may present a workflow 305 configured in an application, and may provide a control 310 for managing the workflow 305.

Upon receiving a selection of the control 310, the electronic device 110 may present a configuration panel 315 of the workflow 305. The electronic device 110 may provide a first configuration control 320 and a second configuration control 325 in the configuration panel 315.

At block 220, the electronic device 110 sets the target processing component to an asynchronous operating mode via the first configuration control.

As shown in FIG. 3A, the electronic device 110 may receive a setting operation for the first configuration control 320 and may set the workflow 305 accordingly to an asynchronous operating mode. In some embodiments, if the workflow or image flow is set to the asynchronous operating mode, a plurality of processing nodes in the workflow or image flow will also be set to the asynchronous operating mode accordingly.

Further, as shown in FIG. 3A, the electronic device 110 may further obtain a target response content via the second configuration control 325. Accordingly, the application may provide the set target response content to the user when the workflow 305 is triggered to operate asynchronously. In some embodiments, if the user does not set any target response content, the application may provide, for example, a preset response content.

In some embodiments, whether a processing component to operate asynchronously may also be set in a configuration interface or a management interface of the processing component. Additionally, the application editing interface may support modifications to whether the processing component operates asynchronously.

In block 230, the electronic device 110 creates a target application including a target processing component, the target application configured to, during an operation of the target processing component based on a trigger by a first message and in response to receiving a second message, process the second message without waiting for completion of the operation of the target processing component.

The asynchronous operation of the workflow 305 is described below with reference to an example debugging process of the target application. As shown in FIG. 3B, the target application may receive a first message 340 and invoke the workflow 305 accordingly to process the first message 340.

Since the workflow 305 is configured to operate in an asynchronous operation mode, the target application may, for example, provide a reply message 345. The reply message 345 may be obtained based on the input to the second configuration control 325 as described above, or the reply message 345 may include a preset response content.

Further, the target application may further receive a second message 355 before completion of execution of the invoked workflow 305 and without waiting for the completion of the execution of the workflow 305. That is, the target application may receive a new message, process a new message, or generate a response content for the new message independently of an operating state of the workflow 305. For example, the target application may further process the second message 355 and generate a corresponding reply message 360.

Additionally, in response to completion of processing of the first message 340 by the workflow 305, the target application may provide a response content 365 for the first message based on a processing result of the target processing component.

In some embodiments, to further specify that the response content 365 corresponds to the first message 340, the response content 365 may also indicate a reference to the first message 340. For example, the response content 365 may present the content of the referenced first message 340.

In some examples, if the response content 365 includes a plurality of reply messages, the target application may include a reference element into a first reply message of the plurality of reply messages to indicate a reference to the first message 340.

In some embodiments, upon completion of the processing of the first message 340, context information of the target application may be updated. For example, the target application may update the context information based on the first message 340 and the response content 365 for the first message 340.

As an example, if the response content 365 includes a single reply message, the target application may update the context information based on a pair of messages (i.e., the first message 340 and the reply message). As another example, if the response content 365 includes a plurality of reply messages, the plurality of reply messages may be combined into an aggregated reply message, for example. The target application may update the context information based on the message pair (i.e., the first message 340 and the aggregated reply message).

In some embodiments, during debugging or running of a target application, a debug interface or a running interface of the target application may further present task description information associated with an asynchronous task triggered to operate. Such task description information may be configured to describe a set of asynchronous tasks triggered during the running of the target application.

Taking the debug interface shown in FIG. 3B as an example, the electronic device 110 can present a task management panel 370 based on the user's selection of a task viewing portal 335. The task management panel 370 may be configured to present task description information 375 associated with the asynchronous task that is triggered to operate.

As shown in FIG. 3B, such task description information 375 may indicate a component identifier of a processing component corresponding to a respective asynchronous task. For example, the task description information 375 may include a name (e.g., WORK_FLOW A) and type (e.g., workflow) of the processing component that is triggered to operate.

Additionally, the task description information 375 may further indicate an input message that triggers a respective asynchronous task. For example, the task description information 375 may present the content of the user query that triggers the task to operate.

Additionally, the task description information 375 may further indicate a processing state of the respective asynchronous task. For example, the task description information 375 may indicate that the task corresponding to the workflow 305 is processing.

In some embodiments, the task management panel 370 may further include a management portal configured to manage a set of asynchronous tasks. For example, the task management panel 370 may provide a portal for deleting a task, a portal for re-executing a task, a portal for pausing execution of a task, etc.

FIG. 3C illustrates an example running interface 300C according to some embodiments of the disclosure. As illustrated in FIG. 3C, during running of the target application, when a processing component in an asynchronous operating mode is triggered, the target application may receive and process an additional message without waiting for completion of execution of the processing component. This process may be understood with reference to the debugging process described in FIG. 3B, and details are omitted herein.

In some embodiments, to facilitate task management in a conversation interface, the target application may, for example, present in the running interface a reminder message 380 associated with a set of asynchronous tasks that are triggered to execute. For example, the reminder message 380 may indicate the number of asynchronous tasks in the target application that are triggered to execute.

Further, the target application may receive a selection of the reminder message 380 and may present a task management panel 385 accordingly. Similar to the task management panel 370 in the debug interface 300B, the task management panel 385 can present task description information for the set of asynchronous tasks. Details of the task description information may be understood with reference to the content as described above, and details are omitted herein.

In some embodiments, the reminder message 380 described above may be generated based on a query message input by a user. For example, the user may enter “how many tasks are currently being executed” into the conversation window, and accordingly the target application may provide the reminder message 380 regarding the asynchronous tasks that are currently executed.

In some embodiments, the task description information may also be provided in other suitable manners, such as by way of a conversation message. For example, the target application may also present task description information about the set of asynchronous tasks in the form of a text message.

Additionally, the target application may also support the user to manage such tasks by inputting a message, for example. For example, the user can trigger the target application to delete the first asynchronous task in the list, e.g., by inputting “delete the first task” into the conversation window.

In some embodiments, when the target application includes a plurality of asynchronous tasks, the target application may further adjust an execution order of the plurality of asynchronous tasks based on a preset operation of the user. For example, the user may change the execution order of the tasks by moving the present order of the plurality of asynchronous tasks in the task management panel. As another example, the user may also manage the execution order of the asynchronous tasks by inputting a message, for example.

Based on the processes described above, the embodiments of the present disclosure can support configuring a particular processing component in an application to operate asynchronously, thereby improving the execution efficiency of the application.

FIG. 2B illustrates a flowchart of a process 200B for processing a request according to some embodiments of the disclosure. The process 200B may be implemented at the electronic device 110. The process 200B is described below with reference to FIG. 1.

As shown in FIG. 2B, at block 240, the electronic device 110 triggers a target processing component of the target application to operate based on a first message received by the target application, the target processing component being configured to operate in an asynchronous operating mode.

At block 250, the electronic device 110 receives a second message via the target application before completion of execution of the target processing component.

At block 260, independently of an operating state of the target processing component, the electronic device 110 provides a first response content for the second message.

In some embodiments, the process 200B further includes presenting task description information in a target interface associated with the target application, the task description information being configured to describe a set of asynchronous tasks triggered during running of the target application.

In some embodiments, the task description information indicates at least one of the following: a component identifier of a processing component corresponding to a respective asynchronous task; an input message for triggering a respective asynchronous task; or a processing state of a respective asynchronous task.

In some embodiments, the process 200B further includes presenting, in the target interface, a management portal configured to manage the set of asynchronous tasks.

In some embodiments, the target interface includes a debug interface of the target application, and presenting the task description information in the target interface associated with the target application includes: in response to a selection of a task viewing portal in the debug interface, presenting the task description information in a first task management panel.

In some embodiments, the target interface includes a running interface of the target application, and presenting the task description information in the target interface associated with the target application includes: presenting, in the target interface, a reminder message associated with the set of asynchronous tasks; and in response to a selection of the reminder message, presenting the task description information in a second task management panel.

In some embodiments, the process 200B further includes in response to completion of processing of the first message by the target processing component, providing a second response content for the first message, the second response content indicating a reference to the first message.

In some embodiments, the second response content includes a plurality of reply messages, and the first reply message of the plurality of reply messages includes a reference element indicating a reference to the first message.

### Example Apparatus and Devices

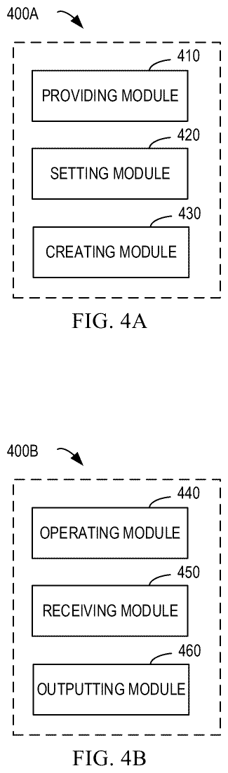

The embodiments of the present disclosure further provide a corresponding apparatus for implementing the methods or processes described above. FIG. 4A illustrates a schematic structural block diagram of an example apparatus 400A for application creation according to some embodiments of the present disclosure. The apparatus 400A may be implemented as or included in the electronic device 110. The various modules/components in the apparatus 400A may be implemented by hardware, software, firmware, or any combination thereof.

As shown in FIG. 4A, the apparatus 400A includes: a providing module 410 configured to provide, in an application editing interface, a first configuration control associated with a target processing component; a setting module 420 configured to set the target processing component to an asynchronous operating mode via the first configuration control; and a creating module 430 configured to create a target application including the target processing component, the target application being configured to, during an operation of the target processing component based on a trigger by a first message and in response to receiving a second message, process the second message without waiting for completion of the operation of the target processing component.

In some embodiments, the apparatus 400A further includes a response configuration module configured to obtain a target response content via a second configuration control associated with the target processing component, and the target application is configured to provide the target response content when the target processing component is triggered to execute by the first message and before completion of the execution of the target processing component.

In some embodiments, the apparatus 400A further includes a task viewing module configured to trigger presentation of task description information in a target interface associated with a target application, the task description information being configured to describe a set of asynchronous tasks triggered during running of the target application.

In some embodiments, the task description information indicates at least one of: a component identifier of a processing component corresponding to a respective asynchronous task; an input message for triggering a respective asynchronous task; or a processing state of a respective asynchronous task.

In some embodiments, the target interface also includes a management portal configured to manage the set of asynchronous tasks.

In some embodiments, the target interface includes a debug interface of the target application, and the task viewing module is further configured to present, in response to a selection of a task viewing portal in the debug interface, the task description information in a first task management panel.

In some embodiments, the target interface includes a running interface of the target application, and the task viewing module is further configured to: trigger presentation of a reminder message associated with the set of asynchronous tasks in the target interface; and in response to a selection of the reminder message, trigger presentation of task description information in a second task management panel.

In some embodiments, the target application is further configured to provide in response to completion of processing of the first message by the target processing component, a response content for the first message, the second content indicating a reference to the first message.

In some embodiments, the response content includes a plurality of reply messages, and a first reply message of the plurality of reply messages includes a reference element indicating a reference to the first message.

In some embodiments, the target processing component includes at least one of: a workflow component; an image flow component; a plug-in component; or a trigger component.

In some embodiments, in response to the workflow component or the image flow component being set to the asynchronous operating mode, a plurality of processing nodes in the workflow component or the image flow component are set to the asynchronous operating mode.

The embodiments of the present disclosure also provide a corresponding apparatus for implementing the methods or processes described above. FIG. 4B illustrates a schematic structural block diagram of an example apparatus 400B for processing a request according to some embodiments of the present disclosure. The apparatus 400B may be implemented as or included in the electronic device 110. The various modules/components in the apparatus 400B may be implemented by hardware, software, firmware, or any combination thereof.

As shown in FIG. 4B, the apparatus 400B includes: an operating module 440 configured to trigger a target processing component of a target application to operate based on a first message received by the target application, the target processing component being configured to operate in an asynchronous operating mode; a receiving module 450 configured to receive a second message via the target application before completion of execution of the target processing component; and an outputting module 460 configured to provide a first response content for the second message independently of an operation state of the target processing component.

In some embodiments, the apparatus 400B further includes a task management module configured to present task description information in a target interface associated with the target application, the task description information being configured to describe a set of asynchronous tasks triggered during running of the target application.

In some embodiments, the task description information indicates at least one of: a component identifier of a processing component corresponding to a respective asynchronous task; an input message for triggering a respective asynchronous task; or a processing state of a respective asynchronous task.

In some embodiments, the task management module is further configured to present a management portal in the target interface for managing the set of asynchronous tasks.

In some embodiments, the target interface includes a debug interface of the target application, and the task management module is further configured to present task description information in a first task management panel in response to a selection of a task viewing portal in the debug interface.

In some embodiments, the target interface includes a running interface of the target application, and the task management module is further configured to: present, in the target interface, a reminder message associated with the set of asynchronous tasks; and in response to a selection of the reminder message, presenting the task description information in a second task management panel.

In some embodiments, the output module 460 is further configured to provide a second response content for the first message in response to completion of processing of the first message by the target processing component, the second response content indicating a reference to the first message.

In some embodiments, the second response content includes a plurality of reply messages, and a first reply message of the plurality of reply messages includes a reference element indicating a reference to the first message.

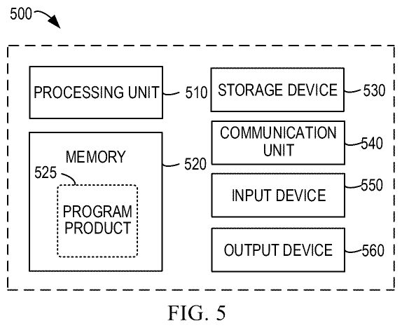

FIG. 5 illustrates a block diagram of an electronic device 500 in which one or more embodiments of the present disclosure may be implemented. It would be appreciated that the electronic device 500 shown in FIG. 5 is merely exemplary and should not constitute any limitation on the functionality and scope of the embodiments described herein. The electronic device 500 shown in FIG. 5 may be used to implement the electronic device 110 of FIG. 1.

As shown in FIG. 5, the electronic device 500 is in the form of a general-purpose electronic device. The components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and capable of performing various processes according to a program stored in the memory 520. In a multiprocessor system, a plurality of processing units execute computer-executable instructions in parallel to improve the parallel processing capabilities of electronic device 500.

The electronic device 500 typically includes a variety of computer storage media. Such media may be any available media that is accessible to the electronic device 500, including, but not limited to, volatile and non-volatile media, removable and non-removable media. The memory 520 may be a volatile memory (e.g., a register, cache, random access memory (RAM)), non-volatile memory (e.g., read-only memory (ROM), electrically erasable programmable read-only memory (EEPROM), flash memory), or some combination thereof. The storage device 530 may be a removable or non-removable medium and may include a machine-readable medium, such as a flash drive, magnetic disk, or any other medium that can be used to store information and/or data and that can be accessed within the electronic device 500.

The electronic device 500 may further include an additional removable/non-removable, volatile/non-volatile storage medium. Although not shown in FIG. 5, a disk drive for reading from or writing to a removable, non-volatile magnetic disk (e.g., a “floppy disk”) or an optical disk drive for reading from or writing to a removable, non-volatile optical disk may be provided. In these cases, each drive may be connected to a bus (not shown) by one or more data media interfaces. The memory 520 may include a computer program product 525 having one or more program modules configured to execute various methods or actions of the various embodiments of the present disclosure.

The communication unit 540 is configured to communicate with other electronic devices through a communication medium. Additionally, the functionality of components of the electronic device 500 may be implemented by a single computing cluster or multiple computing machines capable of communicating through a communication connection. Thus, the electronic device 500 may operate in a networked environment using a logical connection with one or more other servers, network personal computers (PCs), or another network node.

The input device 550 may be one or more input devices such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed. The external device, such as a storage device, a display device, etc., communicates with one or more devices that enable users to interact with the electronic device 500, or communicates with any device (e.g., a network card, a modem, etc.) that enables the electronic device 500 to communicate with one or more other electronic devices. Such communication may be performed via an input/output (I/O) interface (not shown).

According to the example implementations of the present disclosure, a computer-readable storage medium having computer-executable instructions stored thereon is provided. The computer-executable instructions are executed by a processor to implement the method described above. According to example implementations of the present disclosure, a computer program product is further provided. The computer program product is tangibly stored on a non-transitory computer-readable medium and includes computer-executable instructions. The computer-executable instructions are executed by a processor to implement the method described above.

Various aspects of the present disclosure are described herein with reference to flowcharts and/or block diagrams of methods, apparatuses, devices, and computer program products implemented according to the present disclosure. It would be appreciated that each block of the flowchart and/or block diagram, and combinations of blocks in the flowcharts and/or block diagrams, may be implemented by computer readable program instructions.

These computer-readable program instructions may be provided to a processing unit of a general-purpose computer, special computer, or other programmable data processing apparatus to produce a machine that generates a device to implement the functions/acts specified in one or more blocks in the flow chart and/or the block diagram when these instructions are executed through the processing units of the computer or other programmable data processing devices. These computer-readable program instructions may also be stored in a computer-readable storage medium. These instructions cause the computer, programmable data processing apparatus, and/or other devices to work in a specific way. Therefore, the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other devices, such that a series of operational steps can be performed on a computer, other programmable data processing apparatus, or other devices to produce a computer-implemented process such that the instructions executed on a computer, other programmable data processing apparatus, or other apparatus implement the functions/acts specified in the flowchart and/or block diagram block or blocks.

The flowchart and block diagrams in the drawings show the possible architecture, functions and operations of the system, the method, and the computer program product implemented according to various implementations of the present disclosure. In this regard, each block in the flowchart or block diagram may represent a part of a module, a program segment or instructions, which contains one or more executable instructions for implementing the specified logic function. In some alternative implementations, the functions marked in the block may also occur in a different order from those marked in the drawings. For example, two consecutive blocks may be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Various implementations of the present disclosure have been described above. The above description is exemplary, not exhaustive, and the present application is not limited to the disclosed implementations. Without departing from the scope and spirit of the described implementations, many modifications and changes are obvious to those skilled in the art. The terminology used herein has been chosen to best explain the principles of the respective implementations, the practical applications or improvements to the technology in the marketplace, or to enable those skilled in the art to understand the implementations disclosed herein.

1. A method for application creation, comprising:
providing, in an application editing interface, a first configuration control associated with a target processing component;
setting the target processing component to an asynchronous operating mode via the first configuration control; and
creating a target application comprising the target processing component, the target application being configured to, during an operation of the target processing component based on a trigger by a first message and in response to receiving a second message, process the second message without waiting for completion of the operation of the target processing component.

2. The method of claim 1, further comprising:
obtaining a target response content via a second configuration control associated with the target processing component, and the target application being configured to provide the target response content when the target processing component is triggered to execute by the first message and before completion of the execution of the target processing component.

3. The method of claim 1, wherein the target processing component comprises at least one of the following:
a workflow component,
an image flow component,
a plug-in component, or
a trigger component.

4. The method of claim 3, wherein in response to the workflow component or the image flow component being set to the asynchronous operating mode, a plurality of processing nodes in the workflow component or the image flow component are set to the asynchronous operating mode.

5. A method for processing a request comprising:
triggering a target processing component of a target application to operate based on a first message received by the target application, the target processing component being configured to operate in an asynchronous operating mode;
receiving a second message via the target application before completion of execution of the target processing component; and
providing a first response content for the second message independently of an operation state of the target processing component.

6. The method of claim 5, further comprising:
presenting task description information in a target interface associated with the target application, wherein the task description information is configured to describe a set of asynchronous tasks triggered during running of the target application.

7. The method of claim 6, wherein the task description information indicates at least one of the following:
a component identifier of a processing component corresponding to a respective asynchronous task,
an input message for triggering a respective asynchronous task, or
a processing state of a respective asynchronous task.

8. The method of claim 6, further comprising:
presenting, in the target interface, a management portal configured to manage the set of asynchronous tasks.

9. The method of claim 6, wherein the target interface comprises a debug interface of the target application, and presenting the task description information in the target interface associated with the target application comprises:
in response to a selection of a task viewing portal in the debug interface, presenting the task description information in a first task management panel.

10. The method of claim 6, wherein the target interface comprises a running interface of the target application, and presenting the task description information in the target interface associated with the target application comprises:
presenting, in the target interface, a reminder message associated with the set of asynchronous tasks; and
in response to a selection of the reminder message, presenting the task description information in a second task management panel.

11. The method of claim 5, further comprising:
in response to completion of processing of the first message by the target processing component, providing a second response content for the first message, the second response content indicating a reference to the first message.

12. The method of claim 11, wherein the second response content comprises a plurality of reply messages, and a first reply message of the plurality of reply messages comprises a reference element indicating a reference to the first message.

13. An electronic device, comprising:
at least one processing unit; and
at least one memory, the at least one memory being coupled to the at least one processing unit and storing instructions for execution by the at least one processing unit, the instructions, when executed by the at least one processing unit, causing the electronic device to perform operations comprising:
providing, in an application editing interface, a first configuration control associated with a target processing component;
setting the target processing component to an asynchronous operating mode via the first configuration control; and
creating a target application comprising the target processing component, the target application being configured to, during an operation of the target processing component based on a trigger by a first message and in response to receiving a second message, process the second message without waiting for completion of the operation of the target processing component.

14. The electronic device of claim 13, wherein the operations further comprise:
obtaining a target response content via a second configuration control associated with the target processing component, and the target application being configured to provide the target response content when the target processing component is triggered to execute by the first message and before completion of the execution of the target processing component.

15. The electronic device of claim 13, wherein the target processing component comprises at least one of the following:
a workflow component,
an image flow component,
a plug-in component, or
a trigger component.

16. The electronic device of claim 15, wherein in response to the workflow component or the image flow component being set to the asynchronous operating mode, a plurality of processing nodes in the workflow component or the image flow component are set to the asynchronous operating mode.

17. The electronic device of claim 13, wherein the target application is further configured to present task description information in a target interface associated with the target application, wherein the task description information is configured to describe a set of asynchronous tasks triggered during running of the target application.

18. The electronic device of claim 17, wherein the task description information indicates at least one of the following:
a component identifier of a processing component corresponding to a respective asynchronous task,
an input message for triggering a respective asynchronous task, or
a processing state of a respective asynchronous task.

19. The electronic device of claim 17, wherein the target application is further configured to present, in the target interface, a management portal configured to manage the set of asynchronous tasks.

20. The electronic device of claim 17, wherein the target interface comprises a debug interface of the target application, and presenting the task description information in the target interface associated with the target application comprises:
in response to a selection of a task viewing portal in the debug interface, presenting the task description information in a first task management panel.
